(19) United States
(12) Patent Application Publication
(10) Pub. No.: US 2022/0393987 A1
(43) Pub. Date: Dec. 8, 2022

(54) METHOD, SYSTEM, AND CONVERSION APPARATUS

(71) Applicant: NEC Corporation, Minato-ku, Tokyo (JP)

(72) Inventor: Anan SAWABE, Tokyo (JP)

(73) Assignee: NEC Corporation, Minato-ku, Tokyo (JP)

(21) Appl. No.: 17/770,486

(22) PCT Filed: Nov. 12, 2019
(86) PCT No.: PCT/JP2019/044409

§ 371 Date: Apr. 20, 2022

(51) Int. Cl. H04L 47/2491; H04W 28/18; H04L 47/125; H04L 9/40

(52) U.S. Cl. CPC H04L 47/2491; H04W 28/18; H04L 47/125; H04L 63/1408

(57) ABSTRACT

In order to able to mislead estimation regarding a transmission source through analysis of a communication traffic, a method according to an aspect of the present disclosure includes: dividing an original communication flow from a source apparatus into a plurality of communication flows matching a selected traffic characteristic; and transmitting a packet belonging to each of the plurality of communication flows to a reconstructing apparatus reconstructing the plurality of communication flows into the original communication flow.

### BACKGROUND

### Technical Field

The present disclosure relates to a method, a system, and a conversion apparatus.

### Background Art

Owing to the spread of Internet of Things (IoT), in which various sorts of things are connected to the Internet via a wireless network, use cases of utilizing IoT in various fields such as factories and farming are expected. At the same time, with various of things being connected to the Internet, there is a fear of higher security risks in IoT communication.

Below is an example of an attack against IoT services. The following assumes remote robot control and monitoring using a network camera. In robot control, control commands arrive from a remote location with low delay, which enables stable control. In monitoring using a network camera, images from the camera arrive at a remote monitoring server with low delay, which enables implementation of real-time monitoring. Regarding such traffic of an IoT device that requires real time property, if a malicious user somehow identifies an IoT service and inserts massive cross traffic in a relay apparatus, deterioration of throughput and increase of communication delay are intentionally caused, which may result in interference in the service. Blocking communication regarding a service that requires real time property is also interference in the service.

In recent years, encryption of communication traffic is promoted, and thus it has become more difficult to acquire crude application-level information from a payload of a packet. At the same time, owing to enhancement of data analysis technology such as statistics and machine learning, analysis of characteristics of communication traffic such as statistical amounts of a packet size and a packet arrival interval has enabled identification of not only a communication protocol but also an application and an IoT device type. Such analysis technology of communication traffic can be utilized for improvement of communication quality for encrypted traffic and the like. However, if a malicious user uses the analysis technology, information of a transmission source of communication traffic may be indirectly estimated, which may lead to an attack to IoT services as described above. Performing a security attack using information of a transmission source indirectly estimated by analyzing communication traffic as described above is known as Traffic analysis attack. With Traffic analysis attack, in particular, a web access destination of a user may be estimated from the communication traffic, and privacy such as access tendency of each user may become known to the malicious user.

For example, NPL 1 describes a method of inducing incorrect estimation for an attack of estimating a web access destination from a traffic characteristic by converting a statistic characteristic of the traffic. Specifically, according to NPL 1, a dummy packet is added, and thereby traffic is increased and a throughput characteristic is converted.

### CITATION LIST

### Non Patent Literature

[NPL 1] Mohsen Imani, et al., “Mockingbird: Defending Against Deep-Learning-Based Website Fingerprinting Attacks with Adversarial Traces,” arXiv: 1902.06626, 2019.

### SUMMARY

### Technical Problem

As described above, in NPL 1, against an attacker who estimates a web access destination from a traffic characteristic, a dummy packet is added, and thereby traffic is increased and a throughput characteristic is converted. However, communication traffic that requires real time property generally has high frequency communication, and thus it is considered that increase of traffic is not effective. Specifically, when a dummy packet is added to communication traffic that requires real time property, the communication traffic has higher frequency communication than before addition, and after all, the communication traffic is regarded as communication traffic that requires real time property. Thus, addition of a dummy packet is not effective against an attacker who wants to estimate a service that requires real time property.

An example object of the present disclosure is to provide a method, a system, and a conversion apparatus that cause incorrect estimation regarding a transmission source through analysis of communication traffic.

### Solution to Problem

A method according to an aspect of the present disclosure includes: dividing an original communication flow from a source apparatus into a plurality of communication flows matching a selected traffic characteristic; and transmitting a packet belonging to each of the plurality of communication flows to a reconstructing apparatus reconstructing the plurality of communication flows into the original communication flow.

A system according to an aspect of the present disclosure includes: a conversion apparatus; and a reconstructing apparatus, wherein the conversion apparatus is configured to divide an original communication flow from a source apparatus into a plurality of communication flows matching a selected traffic characteristic, and transmit a packet belonging to each of the plurality of communication flows to the reconstructing apparatus, and the reconstructing apparatus is configured to receive the packet belonging to each of the plurality of communication flows, and reconstruct the original communication flow from the plurality of communication flows.

A conversion apparatus according to an aspect of the present disclosure includes: a conversion section configured to divide an original communication flow from a source apparatus into a plurality of communication flows matching a selected traffic characteristic; and a transmission section configured to transmit a packet belonging to each of the plurality of communication flows to a reconstructing apparatus reconstructing the plurality of communication flows into the original communication flow.

### Advantageous Effects of Invention

According to the present disclosure, incorrect estimation regarding the transmission source through analysis of the communication traffic can be caused. Note that, according to the present disclosure, instead of or together with the above effects, other effects may be exerted.

### BRIEF DESCRIPTION OF THE DRAWINGS

FIG. 1 illustrates an example of a schematic configuration of a system according to a first example embodiment;

FIG. 2 is a block diagram illustrating an example of a schematic functional configuration of a conversion apparatus according to the first example embodiment;

FIG. 3 is a block diagram illustrating an example of a schematic hardware configuration of the conversion apparatus according to the first example embodiment;

FIG. 4 is a block diagram illustrating an example of a schematic functional configuration of a reconstructing apparatus according to the first example embodiment;

FIG. 5 is a block diagram illustrating an example of a schematic hardware configuration of the reconstructing apparatus according to the first example embodiment;

FIG. 6 illustrates a first example of a cycle and a packet string for each cycle included in a traffic characteristic;

FIG. 7 illustrates a second example of a cycle and a packet string for each cycle included in a traffic characteristic;

FIG. 8 is a flowchart for describing an example of a general flow of conversion policy determination processing according to the first example embodiment;

FIG. 9 illustrates an example of a transmission timing determination method of divided communication flows according to the first example embodiment;

FIG. 10 is a sequence diagram for describing an example of a general flow of processing of conversion and reconstruction of the communication flows according to the first example embodiment;

FIG. 11 illustrates an example of transmission of video traffic without division of the communication flow according to the first example embodiment;

FIG. 12 illustrates an example of transmission of video traffic with division of the communication flow according to the first example embodiment;

FIG. 13 illustrates an example of a schematic configuration of a system according to a second example embodiment;

FIG. 14 is a block diagram illustrating an example of a schematic functional configuration of a conversion apparatus according to the second example embodiment;

FIG. 15 is a block diagram illustrating an example of a schematic hardware configuration of the conversion apparatus according to the second example embodiment;

FIG. 16 is a block diagram illustrating an example of a schematic functional configuration of a reconstructing apparatus according to the second example embodiment;

FIG. 17 is a block diagram illustrating an example of a schematic hardware configuration of the reconstructing apparatus according to the second example embodiment; and

FIG. 18 is a sequence diagram for describing an example of a general flow of processing of conversion and reconstruction of the communication flows according to the second example embodiment.

### DESCRIPTION OF THE EXAMPLE EMBODIMENTS

Hereinafter, example embodiments of the present disclosure will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

### 1. First Example Embodiment

1.1. Configuration of System

1.2. Configuration of Conversion Apparatus

1.3. Configuration of Reconstructing Apparatus

1.4. Operation Example

1.5. First Example Alteration

1.6. Second Example Alteration

1.7. Third Example Alteration

1.8. Fourth Example Alteration

### 2. Second Example Embodiment

2.1. Configuration of System

2.2. Configuration of Conversion Apparatus

2.3. Configuration of Reconstructing Apparatus

2.4. Operation Example

<<1. First Example Embodiment>>

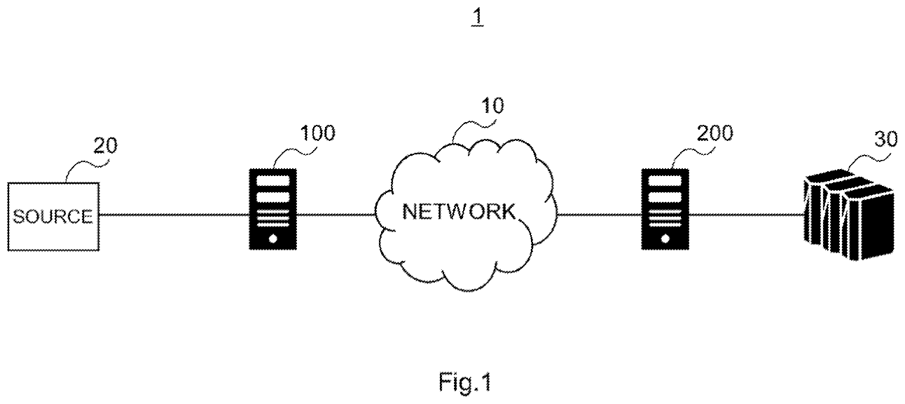

With reference to FIG. 1 to FIG. 12, a first example embodiment of the present disclosure will be described.

<1.1. Configuration of System>

FIG. 1 illustrates an example of a schematic configuration of a system 1 according to the first example embodiment. With reference to FIG. 1, the system 1 includes a network 10, a source apparatus (source device) 20, a destination apparatus (destination device) 30, a conversion apparatus 100, and a reconstructing apparatus 200.

(1) Network 10

For example, the network 10 is a shared network, and malicious observers may observe traffic in the network 10.

(2) Source Apparatus 20 and Destination Apparatus 30

For example, the source apparatus 20 transmits packets (in other words, data) to the destination apparatus 30 via the network 10. For example, a series of packets (a series of data) transmitted from the source apparatus 20 to the destination apparatus 30 may be referred to as traffic or communication traffic. The series of packets (the series of data) may be referred to as a communication flow. The communication flow herein means a series of packets (a series of data) having the same Internet Protocol (IP) address and the same port number, for example. It can be said that the IP address is a location identifier of an apparatus (device), and the port number is an identifier of an application in the apparatus.

For example, the source apparatus 20 is an IoT device, and the destination apparatus 30 is a server (for example, a cloud server) that receives data from the IoT device. Specifically, for example, the source apparatus 20 is an environmental sensor such as a temperature sensor, a network camera (also referred to as a webcam) such as a monitoring camera, or a robot that can be controlled remotely. Note that, as a matter of course, the source apparatus 20 and the destination apparatus 30 are not limited to these examples.

Note that, in FIG. 1, one source apparatus 20 is illustrated. However, as a matter of course, there may be a plurality of source apparatuses 20, and there may be destination apparatuses 30 that correspond to the plurality of source apparatuses 20.

(3) Conversion Apparatus 100 and Reconstructing Apparatus 200

In the first example embodiment, the conversion apparatus 100 receives original communication traffic from the source apparatus 20, and converts the original communication traffic. Through the conversion of the original communication traffic, a traffic characteristic (in other words, a characteristic of communication traffic) is also converted. The conversion apparatus 100 transmits the converted communication traffic to the reconstructing apparatus 200 via the network 10. The reconstructing apparatus 200 reconstructs the original communication traffic from the converted communication traffic, and transmits the original communication traffic to the destination apparatus 30.

More specifically, as will be described later, the conversion apparatus 100 divides the original communication flow from the source apparatus into a plurality of communication flows matching a selected traffic characteristic. The details of the operation will be described later.

The conversion apparatus 100 may be an IoT gateway that accommodates traffic from an IoT device, or may be a proxy server installed in a network of an IoT device. The reconstructing apparatus 200 may be, for example, a proxy server in a network to which a server (for example, a cloud server) that receives data from an IoT device belongs. Note that, as a matter of course, the conversion apparatus 100 and the reconstructing apparatus 200 are not limited to these examples.

<1.2. Configuration of Conversion Apparatus>

(1) Functional Configuration

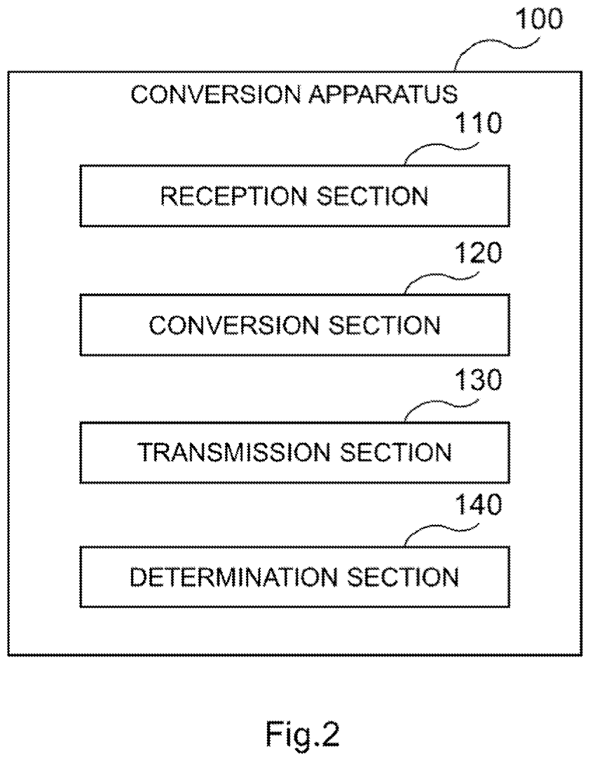

FIG. 2 is a block diagram illustrating an example of a schematic functional configuration of the conversion apparatus 100 according to the first example embodiment. With reference to FIG. 2, the conversion apparatus 100 includes a reception section 110, a conversion section 120, a transmission section 130, and a determination section 140.

Reception Section 110

The reception section 110 receives the original communication traffic from the source apparatus 20. In other words, the reception section 110 receives a packet generated and transmitted from the source apparatus 20. For example, the reception section 110 receives a packet belonging to the original communication flow from the source apparatus 20.

The reception section 110 may receive information necessary for determination of a conversion policy by the determination section 140 (for example, from the source apparatus 20).

Conversion Section 120

The conversion section 120 performs conversion processing regarding the original communication flow in accordance with the conversion policy determined by the determination section 140. Through the conversion processing, the traffic characteristic (in other words, the characteristic of the communication traffic) is converted.

More specifically, as will be described later, the conversion section 120 divides the original communication flow into a plurality of communication flows matching a selected traffic characteristic. The details of the operation will be described later.

Transmission Section 130

The transmission section 130 transmits the packet belonging to each of the plurality of communication flows to the reconstructing apparatus 200.

The transmission section 130 also transmits the conversion policy determined by the determination section 140 to the reconstructing apparatus 200, for example.

Determination Section 140

The determination section 140 determines the conversion policy indicating the communication flow having what kind of traffic characteristic can be obtained through the conversion processing regarding the original communication flow.

(2) Hardware Configuration

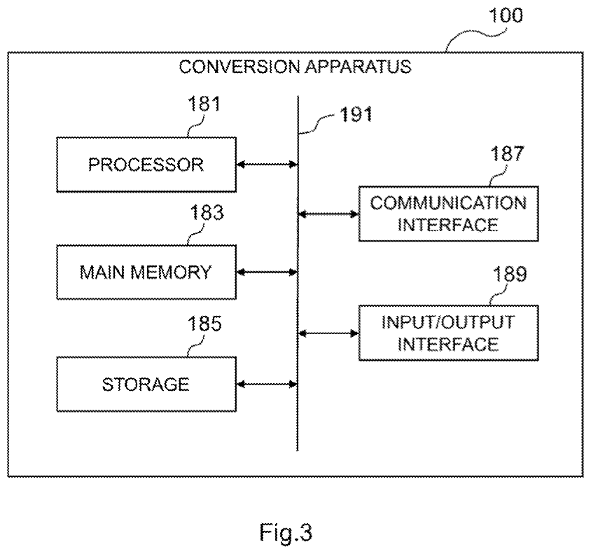

FIG. 3 is a block diagram illustrating an example of a schematic hardware configuration of the conversion apparatus 100 according to the first example embodiment. With reference to FIG. 3, the conversion apparatus 100 includes a processor 181, a main memory 183, a storage 185, a communication interface 187, and an input/output interface 189. The processor 181, the main memory 183, the storage 185, the communication interface 187, and the input/output interface 189 are connected to each other via a bus 191.

The processor 181 executes a program read from the main memory 183. As an example, the processor 181 is a central processing unit (CPU).

The main memory 183 stores programs and various pieces of data. As an example, the main memory 183 is a random access memory (RAM).

The storage 185 stores programs and various pieces of data. As an example, the storage 185 includes a solid state drive (SSD) and/or a hard disk drive (HDD).

The communication interface 187 is an interface for communication with another apparatus. As an example, the communication interface 187 is a network adapter or a network interface card.

The input/output interface 189 is an interface for connection with an input apparatus such as a keyboard and an output apparatus such as a display.

The reception section 110 and the transmission section 130 may be implemented with the processor 181, the main memory 183, and the communication interface 187. The conversion section 120 and the determination section 140 may be implemented with the processor 181 and the main memory 183.

As a matter of course, the hardware configuration of the conversion apparatus 100 is not limited to this example. The conversion apparatus 100 may be implemented with another hardware configuration.

Alternatively, the conversion apparatus 100 may be virtual. In other words, the conversion apparatus 100 may be implemented as a virtual machine. In this case, the conversion apparatus 100 (the virtual machine) may operate as a physical machine (hardware) including a processor, a memory, and the like, and a virtual machine on a hypervisor. As a matter of course, the conversion apparatus 100 (the virtual machine) may be distributed into a plurality of physical machines for operation.

The conversion apparatus 100 may include a memory (main memory 183) that stores programs (instructions), and one or more processors (processor 181) that can execute the programs (instructions). The one or more processors may execute the programs and thereby perform operation of the reception section 110, the conversion section 120, the transmission section 130, and/or the determination section 140. The programs may be programs for causing the processor(s) to execute the operations of the reception section 110, the conversion section 120, the transmission section 130, and/or the determination section 140.

<1.3. Configuration of Reconstructing Apparatus>

(1) Functional Configuration

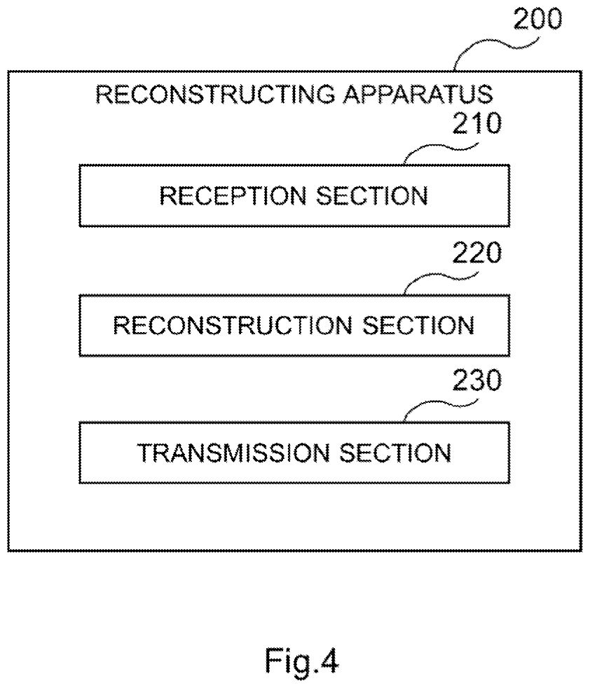

FIG. 4 is a block diagram illustrating an example of a schematic functional configuration of the reconstructing apparatus 200 according to the first example embodiment. With reference to FIG. 4, the reconstructing apparatus 200 includes a reception section 210, a reconstruction section 220, and a transmission section 230.

Reception Section 210

The reception section 210 receives a packet belonging to each of a plurality of communication flows (in other words, divided communication flows) from the conversion apparatus 100.

The reception section 210 also receives a conversion policy from the conversion apparatus 100, for example.

Reconstruction Section 220

The reconstruction section 220 reconstructs the plurality of communication flows (in other words, the divided communication flows) into the original communication flow (in other words, the communication flow before being divided) in accordance with the conversion policy.

Transmission Section 230

The transmission section 230 transmits a packet belonging to the original communication flow to the destination apparatus 30.

(2) Hardware Configuration

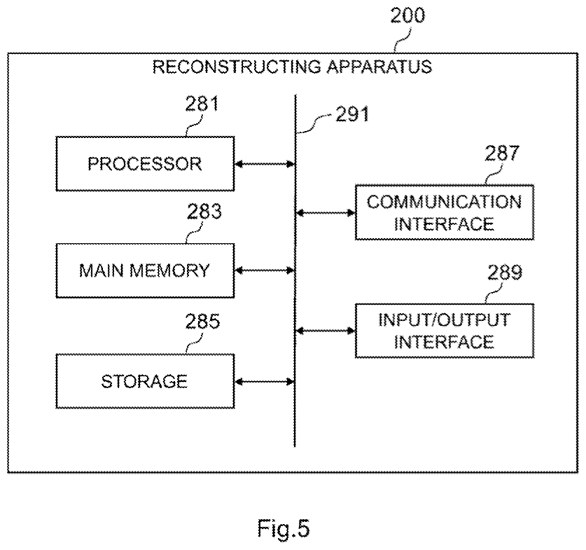

FIG. 5 is a block diagram illustrating an example of a schematic hardware configuration of the reconstructing apparatus 200 according to the first example embodiment. With reference to FIG. 3, the reconstructing apparatus 200 includes a processor 281, a main memory 283, a storage 285, a communication interface 287, and an input/output interface 289. The processor 281, the main memory 283, the storage 285, the communication interface 287, and the input/output interface 289 are connected to each other via a bus 291.

The processor 281 executes a program read from the main memory 283. As an example, the processor 281 is a central processing unit (CPU).

The main memory 283 stores programs and various pieces of data. As an example, the main memory 283 is a random access memory (RAM).

The storage 285 stores programs and various pieces of data. As an example, the storage 285 includes a solid state drive (SSD) and/or a hard disk drive (HDD).

The communication interface 287 is an interface for communication with another apparatus. As an example, the communication interface 287 is a network adapter or a network interface card.

The input/output interface 289 is an interface for connection with an input apparatus such as a keyboard and an output apparatus such as a display.

The reception section 210 and the transmission section 230 may be implemented with the processor 281, the main memory 283, and the communication interface 287. The reconstruction section 220 may be implemented with the processor 281 and the main memory 283.

As a matter of course, the hardware configuration of the reconstructing apparatus 200 is not limited to this example. The reconstructing apparatus 200 may be implemented with another hardware configuration.

Alternatively, the reconstructing apparatus 200 may be virtual. In other words, the reconstructing apparatus 200 may be implemented as a virtual machine. In this case, the reconstructing apparatus 200 (the virtual machine) may operate as a physical machine (hardware) including a processor, a memory, and the like, and a virtual machine on a hypervisor. As a matter of course, the reconstructing apparatus 200 (the virtual machine) may be distributed into a plurality of physical machines for operation.

The reconstructing apparatus 200 may include a memory (main memory 283) that stores programs (instructions), and one or more processors (processor 281) that can execute the programs (instructions). The one or more processors may execute the programs and thereby perform operations of the reception section 210, the reconstruction section 220, and/or the transmission section 230. The programs may be programs for causing the processor(s) to execute the operations of the reception section 210, the reconstruction section 220, and/or the transmission section 230.

<1.4. Operation Example>

In the first example embodiment, the conversion apparatus 100 (conversion section 120) divides the original communication flow from the source apparatus 20 into a plurality of communication flows matching a selected traffic characteristic. The conversion apparatus 100 (transmission section 130) transmits a packet belonging to the plurality of communication flows to the reconstructing apparatus 200.

In addition, in the first example embodiment, the reconstructing apparatus 200 (reception section 210) receives the packet belonging to each of the plurality of flows. The reconstructing apparatus 200 (reconstruction section 220) reconstructs the plurality of communication flows into the original communication flow.

Operation according to the first example embodiment will be described below in more detail.

(1) Advance Preparation

First, as advance preparation, the conversion apparatus 100 (determination section 140) acquires information used for selection of the traffic characteristic that the plurality of communication flows (in other words, the divided communication flows) match.

For example, the source apparatus 20 observes the communication traffic from source apparatus 20, and calculates the traffic characteristic. For example, the source apparatus 20 may observe the traffic of the communication interface of the source apparatus 20. Alternatively, a relay apparatus located between the source apparatus 20 and the destination apparatus 30 may observe the communication traffic from the source apparatus 20.

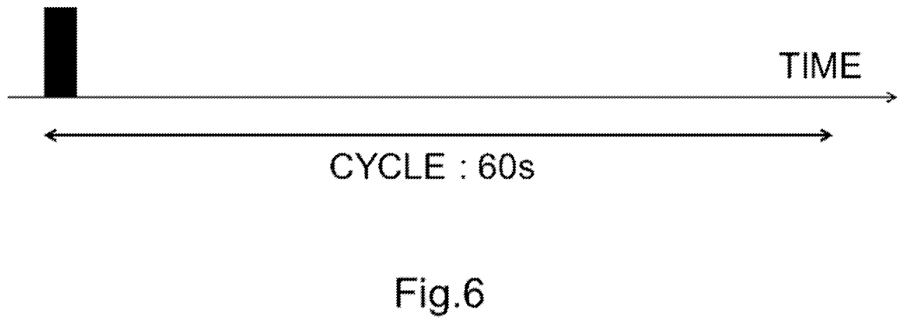

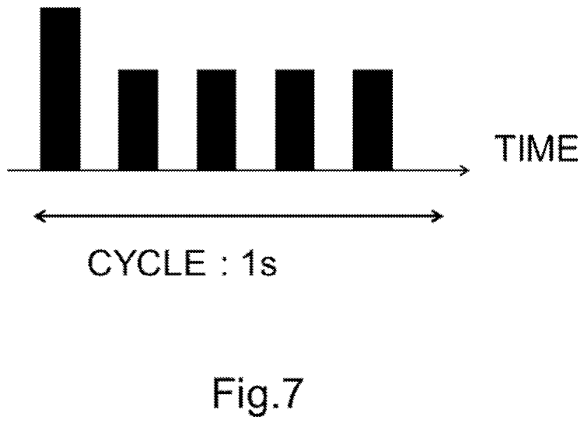

The traffic characteristic includes, for example, distribution of a packet size (bit) and/or a packet arrival interval (s) or statistical amounts (the maximum value, the minimum value, the average value, the median, variance, standard deviation, kurtosis, skewness, and/or the like). In many cases, communication of an IoT device has cyclicity, and thus the traffic characteristic may include a cycle (s) and/or a packet string for each cycle. As an example, the source apparatus 20 may be a temperature sensor that transmits temperature information, and in this case, as illustrated in FIG. 6, the cycle may be 60 seconds (in other words, 60 s), and the packet string for each cycle may be as illustrated in FIG. 6. As another example, as illustrated in FIG. 7, the source apparatus 20 may be a network camera that transmits video information, and in this case, as illustrated in FIG. 7, the cycle may be 1 second (in other words, 1 s), and the packet string for each cycle may be as illustrated in FIG. 7.

For example, the traffic characteristic is associated with a terminal type and a quality-of-service (QoS) indicator. The terminal type is a terminal type of the source apparatus 20, and the QoS indicator is an indicator of quality of service (QoS) required by the source apparatus 20. As an example, the QoS indicator is a qualitative category such as delay sensitive (a characteristic significantly affected by delay, in other words, real time) or delay robust (a characteristic slightly affected by delay, in other words, non-real time). As another example, the QoS indicator may be a range of a quantitative value, such as a delay time of 100 milliseconds (in other words, 100 ms) or less or throughput of 1 Mbps or higher.

The conversion apparatus 100 (determination section 140) acquires, for example, the terminal type, the QoS indicator, and the traffic characteristic. As an example, the source apparatus 20 may be a temperature sensor. In this case, the terminal type may be a model number of the temperature sensor, the QoS indicator may be delay robust, and the traffic characteristic may be acquired from the temperature sensor. As another example, the source apparatus 20 may be a network camera. In this case, the terminal type may be a model number of the network camera, the QoS indicator may be delay sensitive and/or band sensitive, and the traffic characteristic may be acquired from the network camera.

For example, the conversion apparatus 100 acquires a set of the terminal type, the QoS indicator, and the traffic characteristic regarding the plurality of source apparatuses 20. In this manner, the set regarding each of the plurality of source apparatuses 20 is prepared in advance.

(2) Determination of Conversion Policy

The conversion apparatus 100 (determination section 140) determines the conversion policy indicating the communication flow having what kind of traffic characteristic can be obtained through the conversion processing regarding the original communication flow from the source apparatus 20.

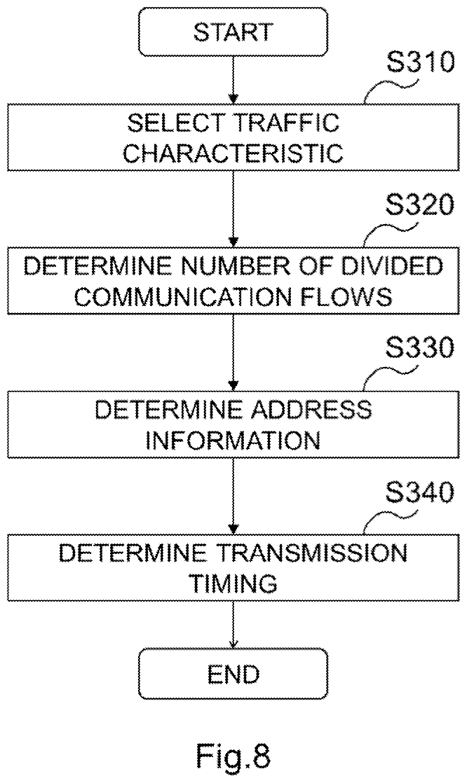

FIG. 8 is a flowchart for describing an example of a general flow of conversion policy determination processing according to the first example embodiment.

For example, first, the conversion apparatus 100 (determination section 140) selects the traffic characteristic that the divided communication flows (in other words, the plurality of communication flows) match (S310). For example, the conversion policy includes the number of divided communication flows, address information of the divided communication flows, and transmission timing of the divided communication flows. The conversion apparatus 100 (determination section 140) determines the number of divided communication flows (S320), determines the address information of the divided communication flows (S330), and determines the transmission timing of the divided communication flows (S340).

S310: Selection of Traffic Characteristic

The conversion apparatus 100 (determination section 140) selects the traffic characteristic that the divided communication flows (in other words, the plurality of communication flows) match (S310).

Traffic Characteristic

The traffic characteristic includes, for example, the packet size (bit) and/or the packet arrival interval (s). The packet size and/or the packet arrival interval may be, for example, distribution of the packet size and/or the packet arrival interval or statistical amounts (for example, the maximum value, the minimum value, the average value, the median, variance, standard deviation, kurtosis, skewness, and/or the like).

The traffic characteristic may include a cycle (s) and/or a packet string for each cycle.

Selection Method

For example, the conversion apparatus 100 (determination section 140) selects the traffic characteristic that the divided communication flows match, based on the information (in other words, the terminal type, the QoS indicator, and/or the traffic characteristic) acquired in the advance preparation.

Configuration of QoS Indicator

Specifically, for example, first, the conversion apparatus 100 (determination section 140) configures a QoS indicator (hereinafter referred to as a “second QoS indicator”) regarding the divided communication flows, based on a QoS indicator (hereinafter referred to as a “first QoS indicator”) regarding the source apparatus 20 acquired in the advance preparation. It can also be said that the first QoS indicator is a QoS indicator of the original communication flow from the source apparatus 20.

For example, the second QoS indicator (in other words, the QoS indicator regarding the divided communication flows) is different from the first QoS indicator (in other words, the QoS indicator of the original communication flow from the source apparatus 20). More specifically, for example, the first QoS indicator corresponds to quality of service that requires real time property, and the second QoS indicator corresponds to quality of service that does not require real time property.

As an example, the first QoS indicator may be delay sensitive, and the second QoS indicator may be configured to delay robust. As another example, the first QoS indicator may be a delay time of 100 ms or less, and the second QoS indicator may be configured to a delay time of 1 s or more.

Owing to such configuration, for example, a certain service can be made appear to be another service. More specifically, for example, a service that requires real time property can be made appear to be a service of non-real time.

Selection of Traffic Characteristic

In addition, for example, the conversion apparatus 100 (determination section 140) selects the traffic characteristic that the divided communication flows match, based on the second QoS indicator (in other words, the QoS indicator regarding the divided communication flows).

As an example, the conversion apparatus 100 (determination section 140) may select one of the terminal types associated with the same QoS indicator as the second QoS indicator (in other words, the QoS indicator regarding the divided communication flows) at random, or may select the traffic characteristic associated with the one terminal type as the traffic characteristic that the divided communication flows match. For example, when the source apparatus 20 is a network camera, the first QoS indicator may be delay sensitive, and the second QoS indicator may be configured to delay robust. In this case, the model number (terminal type) of the temperature sensor associated with delay robust may be selected, and the traffic characteristic associated with the model number (terminal type) of the temperature sensor may be selected.

As another example, the conversion apparatus 100 (determination section 140) may select the traffic characteristic that is closest to the second QoS indicator (for example, a delay time of 1 s or more).

In addition, as another example, the conversion apparatus 100 (determination section 140) may calculate the average value of the traffic characteristics associated with the same QoS indicator as the second QoS indicator, and may select the average value as the traffic characteristic that the divided communication flows match.

Note that not only one traffic characteristic but two or more traffic characteristics may be selected. In other words, the divided communication flows (in other words, the plurality of communication flows) may include one or more communication flows matching each of the two or more traffic characteristics. As an example, the divided communication flows (in other words, the plurality of communication flows) may include one or more communication flows matching a first traffic characteristic (for example, a traffic characteristic of a first temperature sensor) and one or more communication flows matching a second traffic characteristic (for example, a traffic characteristic of a second temperature sensor).

S320: Calculation of Number of Communication Flows

The conversion apparatus 100 (determination section 140) determines the number of divided communication flows, based on the selected traffic characteristic (S320).

For example, the conversion apparatus 100 (determination section 140) determines the number of communication flows that can implement the selected traffic characteristic. In other words, the conversion apparatus 100 (determination section 140) determines the number of divided communication flows (that match the selected traffic characteristic) necessary for reconstruction of the original communication flow.

More specifically, for example, the number (M) of divided communication flows is a number that is obtained by rounding up a result being obtained by dividing [the number of packets in a cycle of the original communication flow] (x) by [the number of packets in a cycle necessary for implementation of the selected traffic characteristic] (N). In other words, the number (M) of divided communication flows is obtained by the following equation.

M=┌x/N┐ [Math. 1]

Alternatively, it can also be said that the number (M) of divided communication flows is a minimum integer that satisfies following relationship.

x≤N×M [Math. 2]

Note that, as described above, not only one traffic characteristic but two or more traffic characteristics may be selected. In this case, the following combinatorial problem may be solved: how many communication flows matching each of the two or more traffic characteristics are necessary for reconstruction of the original communication flow. For example, provided that each of the two or more traffic characteristics is represented by index i, the number of packets in a cycle necessary for implementation of the traffic characteristic i is represented by Ni, the number of communication flows matching the traffic characteristic i is represented by Mi, and the number of packets in a cycle of the original communication flow is represented by x, Mi is a minimum integer that satisfies the following relationship.

x≤ΣNᵢ×Mᵢ [Math. 3]

S330: Determination of Address Information

The conversion apparatus 100 (determination section 140) determines the address information of the divided communication flows (S330). The address information includes an IP address and a port number of each of the divided communication flows.

As described above, for example, the communication flow means a series of packets (a series of data) having the same IP address and the same port number. In other words, the communication flow is identified by the IP address and the port number. For example, the port number is a port number of the Transmission Control Protocol (TCP) or the User Datagram Protocol (UDP).

The plurality of communication flows (in other words, the divided communication flows) are transmitted to the reconstructing apparatus 200. Thus, a destination IP address of each of the plurality of communication flows is the IP address of the reconstructing apparatus 200.

In contrast, each of the plurality of communication flows (in other words, the divided communication flows) is a communication flow different from any other communication flow included in the plurality of communication flows. Thus, a source apparatus IP address, a source port number, and/or a destination port number of each of the plurality of communication flows is a communication flow-specific value.

As an example, when the number of divided communication flows is 100, the source port numbers of the divided communication flows are 20001 to 20100. For example, the source port numbers of the divided communication flows are each a communication flow-specific port number as well. In addition, the source apparatus IP address may be a communication flow-specific IP address as well. Note that the communication flow-specific port numbers or the communication flow-specific IP addresses may be randomly selected values instead of consecutive values.

S340: Determination of Transmission Timing

The conversion apparatus 100 (determination section 140) determines the transmission timing regarding each of the plurality of divided communication flows (S340).

Specifically, for example, the conversion apparatus 100 (determination section 140) determines the transmission timing of each of the plurality of divided communication flows so that the transmission timing of each of the plurality of divided communication flows matches the selected traffic characteristic.

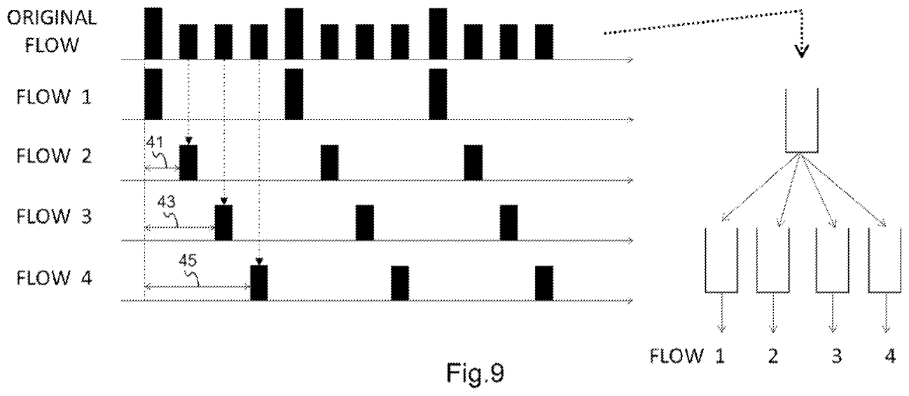

FIG. 9 illustrates an example of a transmission timing determination method of individual divided communication flows according to the first example embodiment. In the example of FIG. 9, the original communication flow (ORIGINAL FLOW) is divided into four communication flows (FLOWs 1 to 4). Regarding the original communication flow, the packet does not necessarily arrive at the same intervals for each cycle due to fluctuation of the communication quality or the like, and thus the packet can be temporarily stored in a buffer. When a packet for communication flow 1 arrives in the original communication flow, the packet is transmitted as a packet belonging to communication flow 1. Next, when a packet for communication flow 2 arrives in the original communication flow, the packet is transmitted as a packet belonging to communication flow 2. Transmission is similarly performed regarding communication flow 3 and communication flow 4 as well. For example, transmission timing of communication flow 1 is a start time point of a cycle, transmission timing of communication flow 2 is a time point that is time 41 later than the start time point of the cycle, transmission timing of communication flow 3 is a time point that is time 43 later than the start time point of the cycle, and transmission timing of communication flow 4 is a time point that is time 45 later than the start time point of the cycle.

The transmission timings of the divided communication flows determined by the conversion apparatus 100 (determination section 140) may be specific timings (the time 41, the time 43, and the time 45) as illustrated in FIG. 9.

(3) Conversion and Reconstruction of Communication Flow

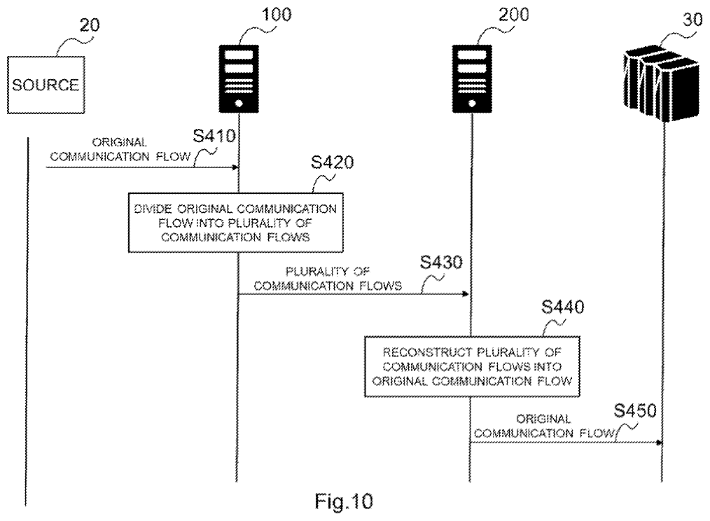

FIG. 10 is a sequence diagram for describing an example of a general flow of processing of conversion and reconstruction of the communication flows according to the first example embodiment.

S410

The source apparatus 20 transmits a packet belonging to the original communication flow (in other words, a packet of data generated by an application operating in the source apparatus 20) (S410). The conversion apparatus 100 (reception section 110) receives the packet belonging to the original communication flow.

S420

The conversion apparatus 100 (conversion section 120) divides the original communication flow from the source apparatus 20 into a plurality of communication flows matching a selected traffic characteristic (S420).

For example, as described above with reference to FIG. 8, the conversion apparatus 100 (determination section 140) selects a traffic characteristic, and determines a conversion policy based on the traffic characteristic. The conversion apparatus 100 (conversion section 120) divides the original communication flow into a plurality of communication flows in accordance with the conversion policy.

For example, the conversion policy includes the number of divided communication flows, and the conversion apparatus 100 (conversion section 120) divides the original communication flow into as many communication flows as the number divided communication flows.

For example, the conversion policy includes address information (the IP address and the port number) of the divided communication flows, and the conversion apparatus 100 (conversion section 120) configures the IP address and the port number to each of the plurality of communication flows in accordance with the address information. In particular, the conversion apparatus 100 (conversion section 120) configures, regarding each of the plurality of communication flows, a communication flow-specific source apparatus IP address, a communication flow-specific source port number, and/or a communication flow-specific destination port number. Note that the conversion apparatus 100 (conversion section 120) configures, regarding each of the plurality of communication flows, a destination IP address to the IP address of the reconstructing apparatus 200.

In this manner, the original communication flow is divided into the plurality of communication flows in accordance with the conversion policy determined based on the traffic characteristic, and thus the characteristic of the communication traffic related to the plurality of communication flows matches the traffic characteristic.

S430

The conversion apparatus 100 (transmission section 130) transmits the packet belonging to each of the plurality of communication flows to the reconstructing apparatus 200 (S430).

For example, the conversion apparatus 100 (transmission section 130) transmits the packet belonging to each of the plurality of communication flows to the reconstructing apparatus 200 at the timing matching the selected traffic characteristic. For example, the conversion policy includes transmission timing of individual packets belonging to each of the divided communication flows, and the conversion apparatus 100 (transmission section 130) transmits the packet belonging to each of the plurality of communication flows to the reconstructing apparatus 200 in accordance with the transmission timing.

The reconstructing apparatus 200 (reception section 210) receives the packet belonging to each of the plurality of communication flows.

S440

The reconstructing apparatus 200 (reconstruction section 220) reconstructs the plurality of communication flows into the original communication flow (S440).

For example, the conversion apparatus 100 (transmission section 130) transmits the conversion policy to the reconstructing apparatus 200. The reconstructing apparatus 200 (reconstruction section 220) reconstructs the original communication flow from the plurality of communication flows in accordance with the conversion policy.

For example, the conversion policy includes the address information (the IP address and the port number) of the divided communication flows, and the address information (the IP address and the port number) of the original communication flow. The reconstructing apparatus 200 (reconstruction section 220) replaces the address information of the divided communication flows (in other words, the plurality of communication flows) with the address information of the original communication flow.

S450

The reconstructing apparatus 200 (transmission section 230) transmits the packet (in other words, reconstructed traffic) belonging to the original communication flow to the destination apparatus 30 (S450). The destination apparatus 30 receives the packet belonging to the original communication flow.

(4) Effects

As described in the above, division and reconstruction of the original communication flow are performed. With this, for example, incorrect estimation regarding the transmission source through analysis of the communication traffic can be caused.

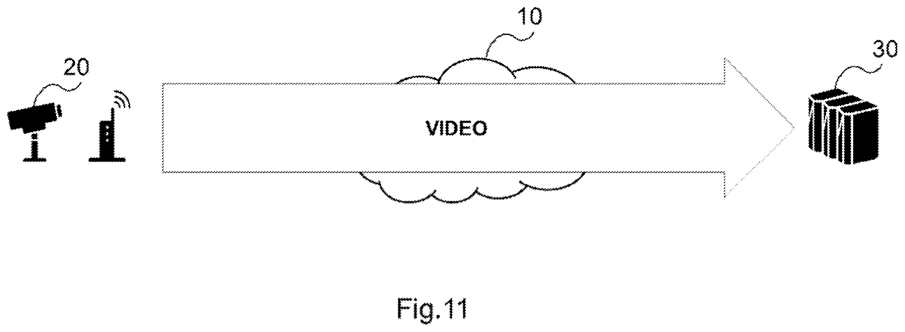

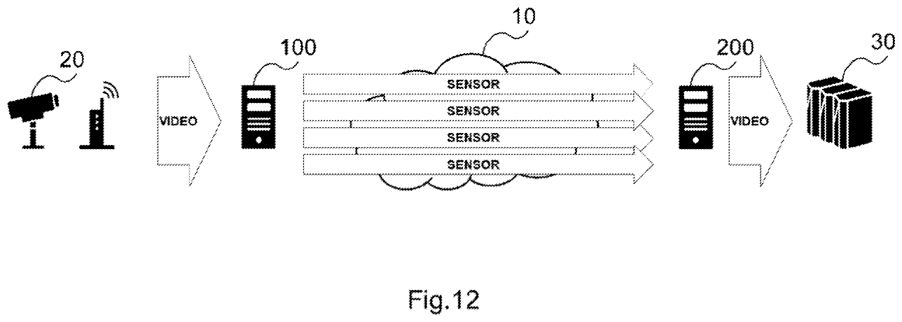

Specifically, estimation regarding the transmission source based on the communication traffic is performed by analyzing the statistical amounts of the characteristic of the communication traffic, such as a packet transmission interval and the packet size. Thus, for example, as illustrated in FIG. 11, when the source apparatus 20 (for example, a network camera) transmits the traffic (for example, video traffic) that requires real time property to the destination apparatus 30, it can be estimated that the statistical amounts of the characteristic of the traffic are analyzed in the network 10, and the traffic that requires real time property is transmitted from the source apparatus 20. In contrast, according to the first example embodiment, as illustrated in FIG. 12, the traffic (for example, video traffic) that requires real time property is, for example, divided into pieces of traffic similar to the traffic (for example, sensor traffic) that does not require real time property. Thus, the statistical amounts of the characteristic of the divided traffic are analyzed in the network 10, and it can be incorrectly estimated that the traffic that does not require real time property is transmitted.

In other words, by dividing the communication flow so that the traffic characteristic (for example, the packet transmission interval, the packet size, and/or the like) is converted, the original traffic (for example, traffic that requires real time property) can be made appear to be other traffic (for example, other traffic that does not require real time property). In other words, by dividing the communication flow and reducing the traffic amount per flow, high frequency communication can be made appear to be low frequency communication. Consequently, incorrect estimation regarding the transmission source through communication traffic analysis can be induced.

<1.5. First Example Alteration>

In the above-described example of the first example embodiment, the original communication flow is divided into a plurality of communication flows. For example, if the number of packets in a cycle of the original communication flow is an integer multiple of the number of communication flows, the packets in the original communication flow can be allocated to a plurality of flows without excess or deficiency.

However, it is not often the case that the number of packets in the cycle of the original communication flow is an integer multiple of the number of flows. In this case, a communication flow having a small number of packets may be present in the divided communication flows, and the communication flow may no longer satisfactorily match the selected traffic characteristic (in particular, the packet arrival interval). As a result, it may be difficult to accurately induce incorrect estimation.

In view of this, in a first example alteration of the first example embodiment, the conversion apparatus 100 (conversion section 120) adds a dummy packet to the communication flow so that the traffic characteristic of the communication flows included in the plurality of communication flows (in other words, the divided communication flows) matches the packet arrival interval included in the selected traffic characteristic.

More specifically, for example, when the number of packets per unit time in the communication flow included in the plurality of communication flows (in other words, the divided communication flows) is smaller than the number of packets corresponding to the packet arrival interval (for example, distribution or statistical amounts) included in the selected traffic characteristic, the conversion apparatus 100 (conversion section 120) adds the dummy packet to the communication flow. In other words, the dummy packet is added to the communication flow whose number of packets per unit time is smaller than the number of packets corresponding to the packet arrival interval included in the selected traffic characteristic out of the plurality of communication flows. The dummy packet has the same address information as the packet included in the communication flow.

Through such addition of the dummy packet (in other words, packet padding), for example, the communication flows included in the plurality of communication flows (in other words, the divided communication flows) match the selected traffic characteristic (in particular, the packet arrival interval). Therefore, incorrect estimation through analysis of the communication traffic can be accurately induced.

Note that, when the dummy packet is added, the reconstructing apparatus 200 (reconstruction section 220) discards the dummy packet at the time of reconstructing the plurality of communication flows (in other words, the divided communication flows) into the original communication flow. In order to enable such discarding of the dummy packet, the conversion apparatus 100 (conversion section 120) provides identification information to a header or a payload (for example, several bits at the end) of the dummy packet. The reconstructing apparatus 200 (reconstruction section 220) identifies the packet including the identification information as the dummy packet, and discards the packet (in other words, the dummy packet).

<1.6. Second Example Alteration>

When data having a large size is transmitted by the source apparatus 20, the data is fragmented into a maximum transmission unit (MTU) being the maximum size of a packet that can be processed in the network. In this case, distribution of the size of the packet transmitted by the source apparatus 20 is impartially on the MTU.

In another case, the distribution of the size of the packet transmitted by the source apparatus 20 may not be impartially on the MTU. For example, the environmental sensor such as the temperature sensor transmits data having a size (for example, approximately from several bytes to several hundreds of bytes) smaller than that of the MTU. In such a case, there may be no traffic characteristic candidates (in particular, packet sizes) that match the communication flows from the source apparatus 20, and it may thus be difficult to select a traffic characteristic that matches the communication flows, and vice versa. In other words, because the packet size in traffic characteristic candidates is small, there may be no traffic characteristic candidates (in particular, packet sizes) that match the communication flows from the source apparatus 20, and it may thus be difficult to select a traffic characteristic that matches the communication flows.

In view of this, in a second example alteration of the first example embodiment, the conversion apparatus 100 (conversion section 120) performs specific processing (for example, division of a packet, addition of dummy bits, or aggregation of packets) on the packet belonging to the original communication flow so that the traffic characteristic of the communication flows included in the plurality of communication flows (in other words, the divided communication flows) matches the packet size included in the selected traffic characteristic.

Note that, when the specific processing is performed, the reconstructing apparatus 200 (reconstruction section 220) also performs reconstruction processing corresponding to the specific processing at the time of reconstructing the original communication flow from the plurality of communication flows (in other words, the divided communication flows). In order to enable such reconstruction processing, the conversion apparatus 100 (conversion section 120) provides identification information to a header or a payload (for example, several bits at the end) of the packet generated in the specific processing. The reconstructing apparatus 200 (reconstruction section 220) identifies the packet including the identification information as the packet generated in the specific processing, and performs the reconstruction processing on the packet. The identification information may be identification information according to details of the specific processing, and the reconstructing apparatus 200 (reconstruction section 220) may identify the details of the specific processing based on the identification information.

(1) First Example: Division of Packet

As the first example, the conversion apparatus 100 (conversion section 120) may divide the packet belonging to the original communication flow into a plurality of packets so that the traffic characteristic of the communication flows included in the plurality of communication flows (in other words, the divided communication flows) matches the packet size included in the selected traffic characteristic.

Specifically, for example, when the size (for example, distribution or statistical amounts) of the packet belonging to the original communication flow is larger than the packet size (for example, distribution or statistical amounts) included in the selected traffic characteristic, the conversion apparatus 100 (conversion section 120) may divide the packet belonging to the original communication flow into a plurality of packets.

As an example, the conversion apparatus 100 (conversion section 120) may divide a packet exceeding a maximum value of distribution of the packet size included in the selected traffic characteristic into packets of a packet size having a high probability of occurrence in the distribution. For example, when the packet belonging to the original communication flow is a packet having 1500 bytes, and the average of the packet sizes is 500 bytes and the maximum value of the packet sizes is 1000 bytes in the selected traffic characteristic, the packet of the original communication flow may be divided into a packet having 500 bytes and a packet having 1000 bytes. Alternatively, the packet of the original communication flow may be divided into two packets each having 750 bytes.

As another example, the conversion apparatus 100 (conversion section 120) may divide a packet exceeding a maximum value of distribution of the packet size included in the selected traffic characteristic into probabilistically selected packets. For example, when ten packets of the original communication flow arrive, and the size of each of the ten packets is 800 bytes, four packets may be selected out of the ten packets, and each of the four packets may be divided into a packet having 500 bytes and a packet having 300 bytes. In this manner, for example, the traffic characteristic of the divided communication flows can be brought close to more natural probability distribution.

For example, division of the packet may be performed as described above. In this manner, for example, the size of the packet is further reduced, and the packet belonging to the divided communication flows matches the packet size included in the selected traffic characteristic. Therefore, incorrect estimation through analysis of the communication traffic can be accurately induced.

Note that, for the sake of the reconstruction processing in the reconstructing apparatus 200, the conversion apparatus 100 (conversion section 120) may provide identification information to a header or a payload (for example, several bits at the end) of each of the plurality of packets (in other words, divided packets). The identification information may indicate the original packets, and order in the original packets.

(2) Second Example: Addition of Dummy Bits

As the second example, the conversion apparatus 100 (conversion section 120) may add dummy bits to the packet belonging to the original communication flow so that the traffic characteristic of the communication flows included in the plurality of communication flows (in other words, the divided communication flows) matches the packet size included in the selected traffic characteristic.

Specifically, for example, when the size (for example, distribution or statistical amounts) of the packet belonging to the original communication flow is smaller than the packet size (for example, distribution or statistical amounts) included in the selected traffic characteristic, the conversion apparatus 100 (conversion section 120) may add dummy bits to the packet belonging to the original communication flow.

As an example, the conversion apparatus 100 (conversion section 120) may add dummy bits to the packet of the original communication flow so that the size of the packet belonging to the original communication flow is the average value of the packet sizes included in the selected traffic characteristic.

For example, addition of dummy bits may be performed as described above. In this manner, for example, the size of the packet is further increased, and the packet belonging to the divided communication flows matches the packet size included in the selected traffic characteristic. Therefore, incorrect estimation through analysis of the communication traffic can be accurately induced.

Note that, for the sake of the reconstruction processing in the reconstructing apparatus 200, the conversion apparatus 100 (conversion section 120) may provide identification information to a header or a payload (for example, several bits at the end) of each packet to which the dummy bits are added. The identification information may indicate the number of added bits and positions of the added bits (for example, the end of the packet or the like).

(3) Third Example: Aggregation of Packets

As the third example, the conversion apparatus 100 (conversion section 120) may aggregate the packet belonging to the original communication flow and one or more other packets so that the traffic characteristic of the communication flows included in the plurality of communication flows (in other words, the divided communication flows) matches the packet size included in the selected traffic characteristic. In other words, the conversion apparatus 100 (conversion section 120) may generate aggregation packets including the packet of the original communication flow and such one or more other packets.

Such one or more other packets may be packets belonging to another original communication flow different from the original communication flow. In other words, packets from a plurality of original communication flows may be aggregated. In addition, such another original communication flow may be a communication flow of another source apparatus 20. In other words, packets from a plurality of source apparatuses 20 may be aggregated.

Specifically, for example, when the size (for example, distribution or statistical amounts) of the packet belonging to the original communication flow is smaller than the packet size (for example, distribution or statistical amounts) included in the selected traffic characteristic, the conversion apparatus 100 (conversion section 120) may aggregate the packet of the original communication flow and such one or more other packets.

As an example, the conversion apparatus 100 (conversion section 120) may aggregate the packet of the original communication flow and such one or more other packets so that the size of the aggregation packets is the average value of the packet sizes included in the selected traffic characteristic.

For example, aggregation of packets may be performed as described above. In this manner, for example, the size of the packet is further increased, and the packet belonging to the divided communication flows matches the packet size included in the selected traffic characteristic. Therefore, incorrect estimation through analysis of the communication traffic can be accurately induced. For example, communication flows from a plurality of apparatuses coexist in the divided communication flows, and thus estimation regarding individual source apparatuses 20 can be more difficult.

Note that, for the sake of the reconstruction processing in the reconstructing apparatus 200, the conversion apparatus 100 (conversion section 120) may provide identification information to a header or a payload (for example, several bits at the end) of the aggregation packets. The identification information may indicate segments between the plurality of packets in the aggregation packets.

<1.7. Third Example Alteration>

The above-described example of the first example embodiment provides description that the conversion apparatus 100 (conversion section 120) divides the original communication flow from the source apparatus 20 into a plurality of communication flows. With this, the original traffic (for example, traffic that requires real time property) can be made appear to be other traffic (for example, other traffic that does not require real time property). However, the first example embodiment is not limited to this example.

In a third example alteration of the first example embodiment, the conversion apparatus 100 (conversion section 120) aggregates the plurality of original communication flows from the source apparatus 20. The conversion apparatus 100 (conversion section 120) may aggregate a plurality of original communication flows from a single source apparatus 20, or may aggregate a plurality of original communication flows from a plurality of source apparatuses 20. In addition, the conversion apparatus 100 (transmission section 130) transmits the aggregated communication flow to the reconstructing apparatus 200.

In this manner as well, the original traffic can be made appear to be other traffic. Therefore, incorrect estimation can be accurately induced.

<1.8. Fourth Example Alteration>

In the above-described example of the first example embodiment, the conversion apparatus 100 is an apparatus different from the source apparatus 20, and the reconstructing apparatus 200 is an apparatus different from the destination apparatus 30. However, the first example embodiment is not limited to this example.

In a fourth example alteration of the first example embodiment, the conversion apparatus 100 may be the source apparatus 20. In other words, the operation or the function of the conversion apparatus 100 may be implemented in the source apparatus 20.

In addition/alternatively, in the fourth example alteration of the first example embodiment, the reconstructing apparatus 200 may be the destination apparatus 30. In other words, the operation or the function of the reconstructing apparatus 200 may be implemented in the destination apparatus 30.

<<2. Second Example Embodiment>>

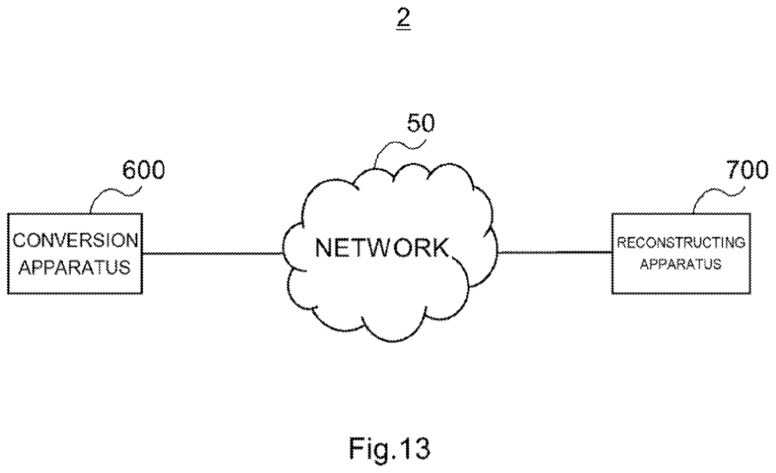

With reference to FIG. 13 to FIG. 18, a second example embodiment of the present disclosure will be described. The above-described first example embodiment is a concrete example embodiment, whereas the second example embodiment is a more generalized example embodiment.

<2.1. Configuration of System>

FIG. 13 illustrates an example of a schematic configuration of a system 2 according to the second example embodiment. With reference to FIG. 2, the system 2 includes a network 50, a conversion apparatus 600, and a reconstructing apparatus 700.

Description regarding the network 50, the conversion apparatus 600, and the reconstructing apparatus 700 is, for example, the same as the description regarding the network 10, the conversion apparatus 100, and the reconstructing apparatus 200 according to the first example embodiment except for the difference of the reference signs. Hence, overlapping descriptions will be omitted here.

Note that, as a matter of course, the network 50, the conversion apparatus 600, and the reconstructing apparatus 700 according to the second example embodiment are not limited to this example.

<2.2. Configuration of Conversion Apparatus>

(1) Functional Configuration

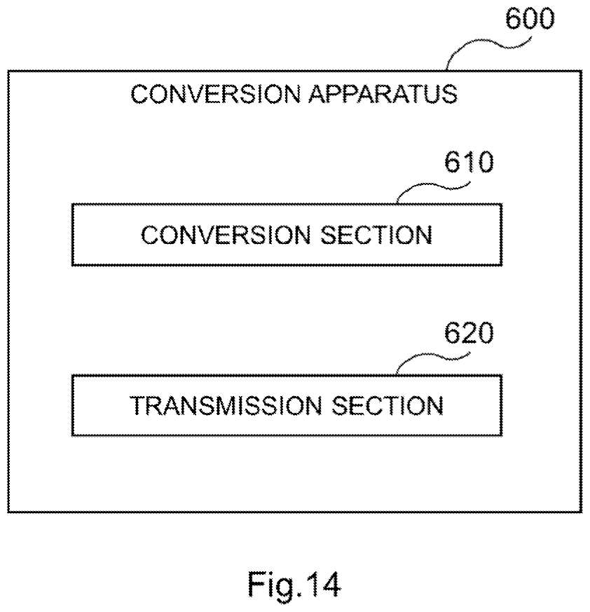

FIG. 14 is a block diagram illustrating an example of a schematic functional configuration of the conversion apparatus 600 according to the second example embodiment. With reference to FIG. 14, the conversion apparatus 600 includes a conversion section 610 and a transmission section 620.

Description regarding the conversion section 610 and the transmission section 620 is, for example, the same as the description regarding the conversion section 120 and the transmission section 130 according to the first example embodiment except for the difference of the reference signs. Hence, overlapping descriptions will be omitted here.

Note that, as a matter of course, the conversion section 610 and the transmission section 620 according to the second example embodiment are not limited to this example.

(2) Hardware Configuration

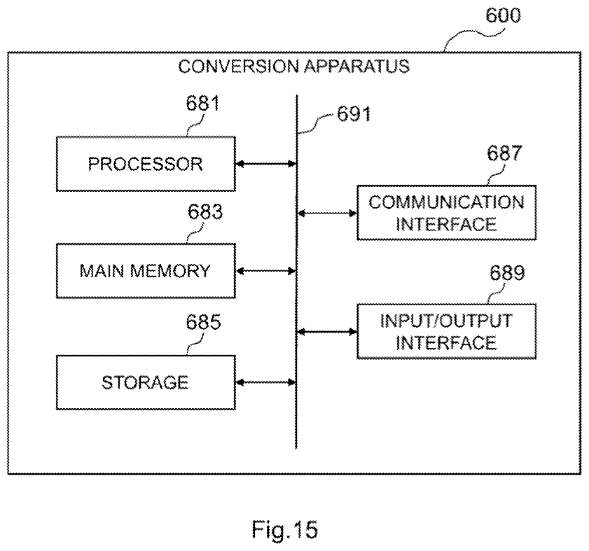

FIG. 15 is a block diagram illustrating an example of a schematic hardware configuration of the conversion apparatus 600 according to the second example embodiment. With reference to FIG. 15, the conversion apparatus 600 includes a processor 681, a main memory 683, a storage 685, a communication interface 687, and an input/output interface 689. The processor 681, the main memory 683, the storage 685, the communication interface 687, and the input/output interface 689 are connected to each other via a bus 691.

Description regarding the hardware configuration of the conversion apparatus 600 is, for example, the same as the description regarding the hardware configuration of the conversion apparatus 100 according to the first example embodiment except for the difference of the reference signs. Hence, overlapping descriptions will be omitted here.

Note that, as a matter of course, the hardware configuration of the conversion apparatus 600 according to the second example embodiment is not limited to this example.

<2.3. Configuration of Reconstructing Apparatus>

(1) Functional Configuration

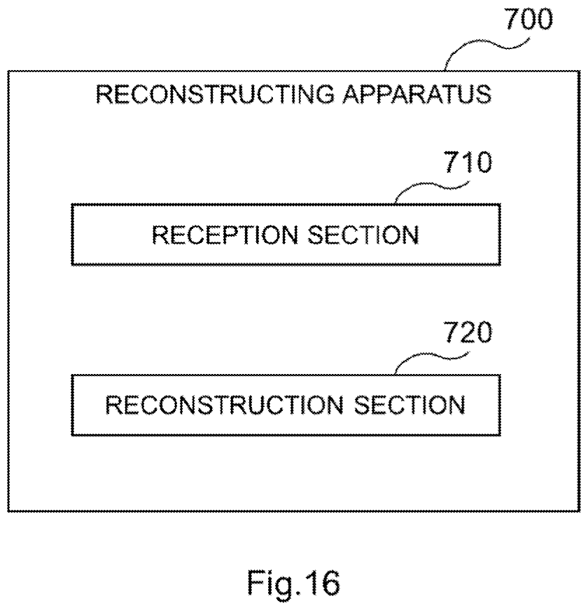

FIG. 16 is a block diagram illustrating an example of a schematic functional configuration of the reconstructing apparatus 700 according to the second example embodiment. With reference to FIG. 16, the reconstructing apparatus 700 includes a reception section 710 and a reconstruction section 720.

Description regarding the reception section 710 and the reconstruction section 720 is, for example, the same as the description regarding the reception section 210 and the reconstruction section 220 according to the first example embodiment except for the difference of the reference signs. Hence, overlapping descriptions will be omitted here.

Note that, as a matter of course, the reception section 710 and the reconstruction section 720 according to the second example embodiment are not limited to this example.

(2) Hardware Configuration

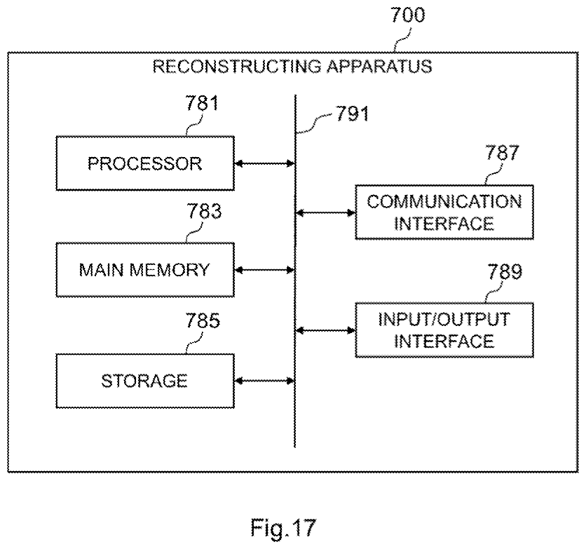

FIG. 17 is a block diagram illustrating an example of a schematic hardware configuration of the reconstructing apparatus 700 according to the second example embodiment. With reference to FIG. 17, the reconstructing apparatus 700 includes a processor 781, a main memory 783, a storage 785, a communication interface 787, and an input/output interface 789. The processor 781, the main memory 783, the storage 785, the communication interface 787, and the input/output interface 789 are connected to each other via a bus 791.

Description regarding the hardware configuration of the reconstructing apparatus 700 is, for example, the same as the description regarding the hardware configuration of the reconstructing apparatus 200 according to the first example embodiment except for the difference of the reference signs. Hence, overlapping descriptions will be omitted here.

Note that, as a matter of course, the hardware configuration of the reconstructing apparatus 700 according to the second example embodiment is not limited to this example.

<2.4. Operation Example>

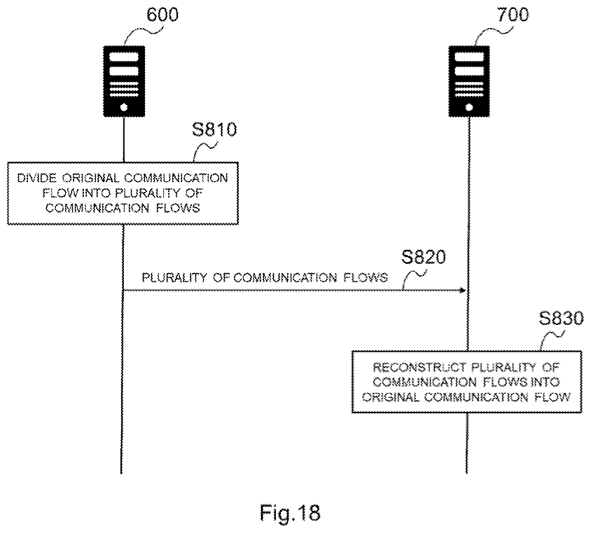

FIG. 18 is a sequence diagram for describing an example of a general flow of processing of conversion and reconstruction of the communication flows according to the second example embodiment.

The conversion apparatus 600 (conversion section 610) divides the original communication flow from the source apparatus into a plurality of communication flows matching a selected traffic characteristic (S810).

The conversion apparatus 100 (transmission section 620) transmits a packet belonging to each of the plurality of communication flows to the reconstructing apparatus 200 (S820). The reconstructing apparatus 200 (reception section 710) receives the packet belonging to each of the plurality of flows.

The reconstructing apparatus 200 (reconstruction section 720) reconstructs the plurality of communication flows into the original communication flow (S830).

Description regarding the conversion and reconstruction of the communication flows is, for example, the same as the description regarding the conversion and reconstruction of the communication flows according to the first example embodiment except for the difference of the reference signs. Hence, overlapping descriptions will be omitted here.

As described in the above, conversion (in other words, division) and reconstruction of the original communication flow are performed. With this, for example, incorrect estimation regarding the transmission source through analysis of the communication traffic can be caused.

Descriptions have been given above of the example embodiments of the present disclosure. However, the present disclosure is not limited to these example embodiments. It should be understood by those of ordinary skill in the art that these example embodiments are merely examples and that various alterations are possible without departing from the scope and the spirit of the present disclosure.

For example, the steps in the processing described in the Specification may not necessarily be executed in time series in the order described in the corresponding flowchart or sequence diagram. For example, the steps in the processing may be executed in an order different from that described in the corresponding flowchart or sequence diagram or may be executed in parallel. Some of the steps in the processing may be deleted, or more steps may be added to the processing.

Moreover, methods including processing of the constituent elements of the conversion apparatus or reconstructing apparatus described in the Specification may be provided, and programs for causing a processor to execute processing of the constituent elements may be provided. Moreover, non-transitory computer readable recording media having recorded thereon the programs may be provided. It is apparent that such methods, programs, and non-transitory computer readable recording media are also included in the present disclosure.

The whole or part of the example embodiments disclosed above can be described as, but not limited to, the following supplementary notes.

### (Supplementary Note 1)

A method comprising:

dividing an original communication flow from a source apparatus into a plurality of communication flows matching a selected traffic characteristic; and

transmitting a packet belonging to each of the plurality of communication flows to a reconstructing apparatus reconstructing the plurality of communication flows into the original communication flow.

### (Supplementary Note 2)

The method according to supplementary note 1, wherein the selected traffic characteristic is a traffic characteristic selected based on a second quality-of-service indicator different from a first quality-of-service indicator regarding the original communication flow.

### (Supplementary Note 3)

The method according to supplementary note 2, wherein

the first quality-of-service indicator corresponds to quality of service that requires real time property, and

the second quality-of-service indicator corresponds to quality of service that does not require the real time property.

### (Supplementary Note 4)

The method according to any one of supplementary notes 1 to 3, wherein the packet belonging to each of the plurality of communication flows is transmitted to the reconstructing apparatus at timing matching the selected traffic characteristic.

### (Supplementary Note 5)

The method according to any one of supplementary notes 1 to 4, further comprising in each of the plurality of communication flows, configuring a communication flow-specific source Internet Protocol (IP) address, a communication flow-specific source port number, or a communication flow-specific destination port number.

### (Supplementary Note 6)

The method according to any one of supplementary notes 1 to 5, wherein

the selected traffic characteristic includes a packet arrival interval, and

the method further comprises adding a dummy packet to a communication flow included in the plurality of communication flows so that the traffic characteristic of the communication flow matches the packet arrival interval.

### (Supplementary Note 7)

The method according to any one of supplementary notes 1 to 6, wherein

the selected traffic characteristic includes a packet size, and

the method further comprises dividing a packet belonging to the original communication flow into a plurality of packets, adding a dummy bit to the packet belonging to the original communication flow, or aggregating the packet belonging to the original communication flow and one or more other packets so that the traffic characteristic of the communication flow included in the plurality of communication flows matches the packet size.

### (Supplementary Note 8)

A system comprising:

a conversion apparatus; and

a reconstructing apparatus, wherein

the conversion apparatus is configured to
divide an original communication flow from a source apparatus into a plurality of communication flows matching a selected traffic characteristic, and
transmit a packet belonging to each of the plurality of communication flows to the reconstructing apparatus, and

the reconstructing apparatus is configured to
receive the packet belonging to each of the plurality of communication flows, and
reconstruct the original communication flow from the plurality of communication flows.

### (Supplementary Note 9)

The system according to supplementary note 8, wherein the selected traffic characteristic is a traffic characteristic selected based on a second quality-of-service indicator different from a first quality-of-service indicator regarding the original communication flow.

### (Supplementary Note 10)

The system according to supplementary note 9, wherein

the first quality-of-service indicator corresponds to quality of service that requires real time property, and

the second quality-of-service indicator corresponds to quality of service that does not require the real time property.

### (Supplementary Note 11)

The system according to any one of supplementary notes 8 to 10, wherein the conversion apparatus is configured to transmit the packet belonging to each of the plurality of communication flows to the reconstructing apparatus at timing matching the selected traffic characteristic.

### (Supplementary Note 12)

The system according to any one of supplementary notes 8 to 11, wherein the conversion apparatus is configured to configure, in each of the plurality of communication flows, a communication flow-specific source Internet Protocol (IP) address, a communication flow-specific source port number, or a communication flow-specific destination port number.

### (Supplementary Note 13)

The system according to any one of supplementary notes 8 to 12, wherein

the selected traffic characteristic includes a packet arrival interval, and

the conversion apparatus is configured to add a dummy packet to a communication flow included in the plurality of communication flows so that the traffic characteristic of the communication flow matches the packet arrival interval.

### (Supplementary Note 14)

The system according to any one of supplementary notes 8 to 13, wherein

the selected traffic characteristic includes a packet size, and

the conversion apparatus is configured to divide a packet belonging to the original communication flow into a plurality of packets, add a dummy bit to the packet belonging to the original communication flow, or aggregate the packet belonging to the original communication flow and one or more other packets so that the traffic characteristic of the communication flow included in the plurality of communication flows matches the packet size.

### (Supplementary Note 15)

A conversion apparatus comprising:

a conversion section configured to divide an original communication flow from a source apparatus into a plurality of communication flows matching a selected traffic characteristic; and

a transmission section configured to transmit a packet belonging to each of the plurality of communication flows to a reconstructing apparatus reconstructing the plurality of communication flows into the original communication flow.

### (Supplementary Note 16)

The conversion apparatus according to supplementary note 15, wherein the selected traffic characteristic is a traffic characteristic selected based on a second quality-of-service indicator different from a first quality-of-service indicator regarding the original communication flow.

### (Supplementary Note 17)

The conversion apparatus according to supplementary note 16, wherein

the first quality-of-service indicator corresponds to quality of service that requires real time property, and

the second quality-of-service indicator corresponds to quality of service that does not require the real time property.

### (Supplementary Note 18)

The conversion apparatus according to any one of supplementary notes 15 to 17, wherein the transmission section is configured to transmit the packet belonging to each of the plurality of communication flows to the reconstructing apparatus at timing matching the selected traffic characteristic.

### (Supplementary Note 19)

The conversion apparatus according to any one of supplementary notes 15 to 18, wherein the conversion section is configured to configure, in each of the plurality of communication flows, a communication flow-specific source Internet Protocol (IP) address, a communication flow-specific source port number, or a communication flow-specific destination port number.

### (Supplementary Note 20)

The conversion apparatus according to any one of supplementary notes 15 to 19, wherein

the selected traffic characteristic includes a packet arrival interval, and

the conversion section is configured to add a dummy packet to a communication flow included in the plurality of communication flows so that the traffic characteristic of the communication flow matches the packet arrival interval.

### (Supplementary Note 21)

The conversion apparatus according to any one of supplementary notes 15 to 20, wherein

the selected traffic characteristic includes a packet size, and

the conversion section is configured to divide a packet belonging to the original communication flow into a plurality of packets, add a dummy bit to the packet belonging to the original communication flow, or aggregate the packet belonging to the original communication flow and one or more other packets so that the traffic characteristic of the communication flow included in the plurality of communication flows matches the packet size.

### (Supplementary Note 22)

A program causing a processor to execute:

dividing an original communication flow from a source apparatus into a plurality of communication flows matching a selected traffic characteristic; and

transmitting a packet belonging to each of the plurality of communication flows to a reconstructing apparatus reconstructing the plurality of communication flows into the original communication flow.

### (Supplementary Note 23)

A non-transitory computer readable recording medium having recorded thereon a program causing a processor to execute:

dividing an original communication flow from a source apparatus into a plurality of communication flows matching a selected traffic characteristic; and

transmitting a packet belonging to each of the plurality of communication flows to a reconstructing apparatus reconstructing the plurality of communication flows into the original communication flow.

### (Supplementary Note 24)

A method comprising:

in a conversion apparatus,
dividing an original communication flow from a source apparatus into a plurality of communication flows matching a selected traffic characteristic, and
transmitting a packet belonging to each of the plurality of communication flows to a reconstructing apparatus; and

in the reconstructing apparatus,
receiving the packet belonging to each of the plurality of communication flows, and
reconstructing the original communication flow from the plurality of communication flows.

### (Supplementary Note 25)

A reconstructing apparatus comprising:

a reception section configured to receive, from a conversion apparatus configured to divide an original communication flow from a source apparatus into a plurality of communication flows matching a selected traffic characteristic, a packet belonging to each of the plurality of communication flows; and

a reconstruction section configured to reconstruct the original communication flow from the plurality of communication flows.

### (Supplementary Note 26)

A method comprising:

receiving, from a conversion apparatus that divides an original communication flow from a source apparatus into a plurality of communication flows matching a selected traffic characteristic, a packet belonging to each of the plurality of communication flows; and

reconstructing the original communication flow from the plurality of communication flows.

### (Supplementary Note 27)

A program causing a processor to execute:

receiving, from a conversion apparatus that divides an original communication flow from a source apparatus into a plurality of communication flows matching a selected traffic characteristic, a packet belonging to each of the plurality of communication flows; and

reconstructing the original communication flow from the plurality of communication flows.

### (Supplementary Note 28)

A non-transitory computer readable recording medium having recorded thereon a program causing a processor to execute:

receiving, from a conversion apparatus that divides an original communication flow from a source apparatus into a plurality of communication flows matching a selected traffic characteristic, a packet belonging to each of the plurality of communication flows; and

reconstructing the original communication flow from the plurality of communication flows.

### REFERENCE SIGNS LIST

1, 2 System

10 Network

20 Source Apparatus

30 Destination Apparatus

100, 600 Conversion Apparatus

120, 610 Conversion Section

130, 620 Transmission Section

200, 700 Reconstructing Apparatus

210, 710 Reception Section

220, 720 Reconstruction Section

What is claimed is:

1. A method comprising:
dividing an original communication flow from a source apparatus into a plurality of communication flows matching a selected traffic characteristic; and
transmitting a packet belonging to each of the plurality of communication flows to a reconstructing apparatus reconstructing the plurality of communication flows into the original communication flow.

2. The method according to claim 1, wherein the selected traffic characteristic is a traffic characteristic selected based on a second quality-of-service indicator different from a first quality-of-service indicator regarding the original communication flow.

3. The method according to claim 2, wherein
the first quality-of-service indicator corresponds to quality of service that requires real time property, and
the second quality-of-service indicator corresponds to quality of service that does not require the real time property.

4. The method according to claim 1, wherein the packet belonging to each of the plurality of communication flows is transmitted to the reconstructing apparatus at timing matching the selected traffic characteristic.

5. The method according to claim 1, further comprising
in each of the plurality of communication flows, configuring a communication flow-specific source Internet Protocol (IP) address, a communication flow-specific source port number, or a communication flow-specific destination port number.

6. The method according to claim 1, wherein
the selected traffic characteristic includes a packet arrival interval, and
the method further comprises
adding a dummy packet to a communication flow included in the plurality of communication flows so that the traffic characteristic of the communication flow matches the packet arrival interval.

7. The method according to claim 1, wherein
the selected traffic characteristic includes a packet size, and
the method further comprises
dividing a packet belonging to the original communication flow into a plurality of packets, adding a dummy bit to the packet belonging to the original communication flow, or aggregating the packet belonging to the original communication flow and one or more other packets so that the traffic characteristic of the communication flow included in the plurality of communication flows matches the packet size.

8. A system comprising:
a conversion apparatus comprising one or more apparatuses each including a memory storing instructions and one or more processors configured to execute the instructions; and
a reconstructing apparatus comprising one or more apparatuses each including a memory storing instructions and one or more processors configured to execute the instructions, wherein
the conversion apparatus is configured to
divide an original communication flow from a source apparatus into a plurality of communication flows matching a selected traffic characteristic, and
transmit a packet belonging to each of the plurality of communication flows to the reconstructing apparatus, and
the reconstructing apparatus is configured to
receive the packet belonging to each of the plurality of communication flows, and
reconstruct the original communication flow from the plurality of communication flows.

9. The system according to claim 8, wherein the selected traffic characteristic is a traffic characteristic selected based on a second quality-of-service indicator different from a first quality-of-service indicator regarding the original communication flow.

10. The system according to claim 9, wherein
the first quality-of-service indicator corresponds to quality of service that requires real time property, and
the second quality-of-service indicator corresponds to quality of service that does not require the real time property.

11. The system according to claim 8, wherein the conversion apparatus is configured to transmit the packet belonging to each of the plurality of communication flows to the reconstructing apparatus at timing matching the selected traffic characteristic.

12. The system according to claim 8, wherein the conversion apparatus is configured to configure, in each of the plurality of communication flows, a communication flow-specific source Internet Protocol (IP) address, a communication flow-specific source port number, or a communication flow-specific destination port number.

13. The system according to claim 8, wherein
the selected traffic characteristic includes a packet arrival interval, and
the conversion apparatus is configured to add a dummy packet to a communication flow included in the plurality of communication flows so that the traffic characteristic of the communication flow matches the packet arrival interval.

14. The system according to claim 8, wherein
the selected traffic characteristic includes a packet size, and
the conversion apparatus is configured to divide a packet belonging to the original communication flow into a plurality of packets, add a dummy bit to the packet belonging to the original communication flow, or aggregate the packet belonging to the original communication flow and one or more other packets so that the traffic characteristic of the communication flow included in the plurality of communication flows matches the packet size.

15. A conversion apparatus comprising:
a memory storing instructions; and
one or more processors configured to execute the instructions to:
divide an original communication flow from a source apparatus into a plurality of communication flows matching a selected traffic characteristic; and
transmit a packet belonging to each of the plurality of communication flows to a reconstructing apparatus reconstructing the plurality of communication flows into the original communication flow.

16. The conversion apparatus according to claim 15, wherein the selected traffic characteristic is a traffic characteristic selected based on a second quality-of-service indicator different from a first quality-of-service indicator regarding the original communication flow.

17. The conversion apparatus according to claim 16, wherein
the first quality-of-service indicator corresponds to quality of service that requires real time property, and
the second quality-of-service indicator corresponds to quality of service that does not require the real time property.

18. The conversion apparatus according to claim 15, wherein the one or more processors are configured to execute the instructions to transmit the packet belonging to each of the plurality of communication flows to the reconstructing apparatus at timing matching the selected traffic characteristic.

19. The conversion apparatus according to claim 15, wherein the one or more processors are configured to execute the instructions to configure, in each of the plurality of communication flows, a communication flow-specific source Internet Protocol (IP) address, a communication flow-specific source port number, or a communication flow-specific destination port number.

20. The conversion apparatus according to claim 15, wherein
the selected traffic characteristic includes a packet arrival interval, and
the one or more processors are configured to execute the instructions to add a dummy packet to a communication flow included in the plurality of communication flows so that the traffic characteristic of the communication flow matches the packet arrival interval.

21. (canceled)
